(19) United States
(12) Patent Application Publication
(10) Pub. No.: US 2024/0372707 A1
(43) Pub. Date: Nov. 7, 2024

(54) PROTECTING SECRETS WITH MULTI-PARTY APPROVAL IN COMPUTER NETWORKS

(71) Applicant: Nvidia Corporation, Santa Clara, CA (US)

(72) Inventors: Daniel Bryan Knobloch, Minneapolis, MN (US); Daniel Jonas Major, Ottawa (CA)

(21) Appl. No.: 18/142,180

(22) Filed: May 2, 2023

(51) Int. Cl. H04L 9/08; H04L 9/14; H04L 9/30; H04L 9/32

(52) U.S. Cl. CPC H04L 9/085; H04L 9/0891; H04L 9/14; H04L 9/30; H04L 9/3213; H04L 2209/46

(57) ABSTRACT

Systems and methods herein are for protecting secrets with multi-party approval in a computer network. One or more processing units enable accumulation of a plurality of encrypted shards that are received at different timepoints and that are associated with a secret. A process that is remote from the server is enabled, upon accumulating a predetermined number of the plurality of encrypted shards, to cause, in communication with a trusted server, decryption and combination to be performed on the plurality of encrypted shards to provide access to the secret.

### TECHNICAL FIELD

At least one embodiment pertains to protecting secrets with multi-party approval in computer networks. For example, a server accumulates encrypted shards from different timepoints and enables a remote process to decrypt and combine them to access a secret.

### BACKGROUND

Secret protection schemes may include splitting a decryption key associated with a secret and sharing the split decryption keys among multiple parties or entities. To access the secret, the split decryption keys may be combined to provide the decryption key. However, the secret itself may be maintained in storage devices, along with the split decryption keys. These storage devices may be accessible via the internet and may be vulnerable to hacking. The internet-based approach may require the split decryption keys to be provided at a same time. The issue of hacking in the internet-based approach may be directed to the storage devices having the secret or the storage devices having the split decryption keys provided at the same time to recombine the keys. For example, a trusted server or a feature-rich frontend server, both being able to perform other tasks along with supporting access to the secret, may be points of vulnerability, including by allowing multiple approvers to conspire to access the secret. Further, accessing a secret may be by a physical-presence-based approach where multiple parties or entities are physically present to submit respective media including the split decryption keys via a computer system, such as on a laptop or other portable device. However, the physical presence requires a predetermined number of approvers to simultaneously approve a process to be performed, where each approver provides their key at the same time to access a secret.

### BRIEF DESCRIPTION OF DRAWINGS

FIG. 1 illustrates a system that is subject to embodiments of one or more processors to protect secrets with multi-party approval in a computer network;

FIG. 2A illustrates part of a sequence for protecting secrets with multi-party approval in a computer network, according to at least one embodiment;

FIG. 2B illustrates a further part of a sequence for protecting secrets with multi-party approval in a computer network, according to at least one embodiment;

FIG. 2C illustrates a part of a key flow for protecting secrets with multi-party approval in a computer network, according to at least one embodiment;

FIG. 2D illustrates a further part of a key flow for protecting secrets with multi-party approval in a computer network, according to at least one embodiment;

FIG. 2E illustrates yet another part of a key flow for protecting secrets with multi-party approval in a computer network, according to at least one embodiment;

FIG. 3A illustrates a part of a key flow for creating a secret and encrypted shards to be used for protecting secrets with multi-party approval in a computer network, according to at least one embodiment;

FIG. 3B illustrates yet another part of a key flow for creating a secret and encrypted shards to be used for protecting secrets with multi-party approval in a computer network, according to at least one embodiment;

FIG. 3C illustrates a part of a sequence for adjusting approvers to be used for protecting secrets with multi-party approval in a computer network, according to at least one embodiment;

FIG. 3D illustrates yet another part of a sequence for adjusting approvers to be used for protecting secrets with multi-party approval in a computer network, according to at least one embodiment;

FIG. 4 illustrates computer and processor aspects of a system for protecting secrets with multi-party approval in a computer network, according to at least one embodiment;

FIG. 5 illustrates a process flow for a system for protecting secrets with multi-party approval in a computer network, according to at least one embodiment;

FIG. 6 illustrates yet another process flow for a system associated with protecting secrets with multi-party approval in a computer network, according to at least one embodiment; and

FIG. 7 illustrates a further process flow for a system associated with protecting secrets with multi-party approval in a computer network, according to at least one embodiment.

### DETAILED DESCRIPTION

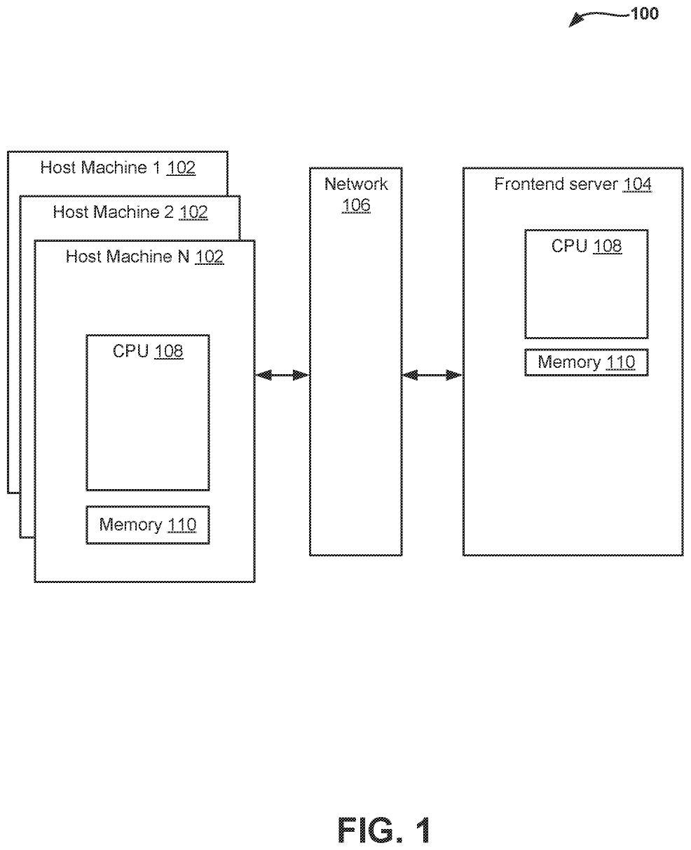

FIG. 1 illustrates a system 100 that is subject to embodiments of one or more processors to protect secrets with multi-party approval in a computer network, as detailed herein. To address inefficiencies described above, in at least one embodiment, software systems may include frontend and backend components, such as servers or processes, to accumulate encrypted shards from different timepoints and to enable at least one process that is in a backend component and that is remote from at least the frontend component to decrypt and to combine the previously encrypted shards to provide access a secret that may be required to perform an application process on the same backend component that is enabled or on a different backend component.

In at least one embodiment, the frontend component may be responsible for authenticating users and authorizing requests. The frontend component may also invoke the backend component to execute a backend process when some criteria is met. The criteria could be an approval flow, where a predetermined number of approvers (associated with a predetermined number of encrypted shards), such as M-of-N permitted users, have provided approval to a request at different timepoints, before the encrypted shards are processed.

In at least one embodiment, the backend process can only be a result of an invocation performed by a frontend component or server to enable access to a secret that is required to execute a process. In at least one embodiment, approaches herein address inefficiencies described above in a manner so that no single person (party, entity, or approver, as used interchangeably herein unless otherwise described) knows or has access to the secret or to the complete key. The party, entity, or approver may include administrators. Certain administrators may be precluded from this requirement, such as by administrators of a HashiCorp Vault® for storing a version of the secret.

In at least one embodiment, the approaches herein for protecting secrets with multi-party approval in a computer network is such that the backend process does not hold onto the secret longer than necessary, but this does not precludes setting the secret in an environment variable at startup. In at least one embodiment, an approval flow or sequence may be followed and may not be circumvented, which can address approvers conspiring to reveal the secret. Further, the approval flow or sequence follows a criteria that can be easily changed or adjusted, for both the approver threshold and a list of approvers.

In at least one embodiment, protecting secrets with multi-party approval in a computer network includes providing each party or entity in the approval flow or sequence with a cryptographic keys that may be used to facilitate secure multi-party approval. In at least one embodiment, automation scripts may be used to handle generation of the secret, as well as used to handle registration of aspects of the system herein that uses the secret and used to handle protection mechanism or schemes described herein for protecting the secret. The protection mechanisms may be chosen based, at least in part, on approval requirements, including a predetermined number of encrypted shards to be used. The approaches herein include separate implementations for one approver or for more than two approvers. Further, the secret is not exposed by the automation script.

In at least one embodiment, there may be prerequisites associated with the multi-party approval in a computer network. A first prerequisite includes that a backend process has to create or receive a third-party key pair (such as an RSA key pair (KeyL), referenced in one or more FIGS. herein). The third-party public key may be created on the backend process or may be created, stored, and provided from a trusted server. Further, the backend process is permitted to use a private key of the key pair to perform decryption. The private key can therefore live in a separate key management system (KMS), also referred to herein as the trusted server. There may be a decrypt policy mapped to the backend process. Only the backend process is able to decrypt an encrypted shard with the private key. Further, a public key of the key pair is made available for encryption of each shard to provide an encrypted shard, in at least one embodiment.

In at least one embodiment, a second prerequisite is that approvers have to have created their key pairs and have to have made their respective public keys available to the system for multi-party approval in a computer network. In at least one embodiment, to make their respective public keys available, a registration may be performed to a host machine of each approver and using the frontend server or using a less-formal sharing with one or more administrators of a system associated with multi-party approval in a computer network.

In at least one embodiment, the protection mechanisms or schemes associated with the multi-party approval in a computer network covers one active approver representing a human user and one system-based approver or covers two active approvers representing two human users. The protection mechanisms or schemes includes, from the approvers side, the secret be encrypted with a random key (such as an AES-256 KeyA, referenced in one or more FIGS. herein). The encryption may also include a random initiation vector (IV, also referenced in one or more FIGS. herein). The combination of the KeyA and IV yields a secret encrypted key (such as secret_enc_KeyA, referenced in one or more FIGS. herein). A splitting process (such as, Shamir's Secret Sharing Scheme) may be used to split KeyA into N shards for N approvers with a predetermined threshold of M (approvals required) to access the secret. Each shard may be encrypted with a respective approver's public key. Further, Optimal Asymmetric Encryption (OAEP) padding may be used with SHA-256 digest for the approver's public key. Therefore, a request associated with the multi-party approval may include the encrypted secret (secret_enc_KeyA), the IV, and a collection of approvers' encrypted shards of KeyA.

In at least one embodiment, where the multi-party approval in a computer network covers one active approver representing a human user and one system-based approver the system-based approver is provided by an extra KeyA shard (such as shard1 in one or more FIGS. herein) that has no designated approver and is returned in the request from the frontend server to a backend process to enable access to the secret. In at least one embodiment, aspects of the protection mechanism or schemes may be stored in a data store that is available to the frontend server. As used herein, the frontend server is understood to a skilled artisan as having the associated data store.

In at least one embodiment, an approval sequence for the multi-party approval may include accumulating, in the frontend server, the encrypted shards that are received at different timepoints. For example, the frontend server accumulates the encrypted shards by collecting and verifying approval response tokens that are signed until a threshold number of approval response tokens is met. For example, the threshold may be a predetermined number of the encrypted shards, described elsewhere herein as M-of-N permitted users and which may vary on a per-request basis. In at least one embodiment, the frontend server is further to enable a backend process upon accumulating a predetermined number of the encrypted shards. For example, the frontend server invokes the backend process on a virtual instance (including a virtual machine) and which may be destroyed (or the underlying data deleted) upon completing its tasks, including one or more of: to finally decrypt a secret, to execute a process using the secret, to split keys, to split secrets, to encrypt shards that include either a key or a secret.

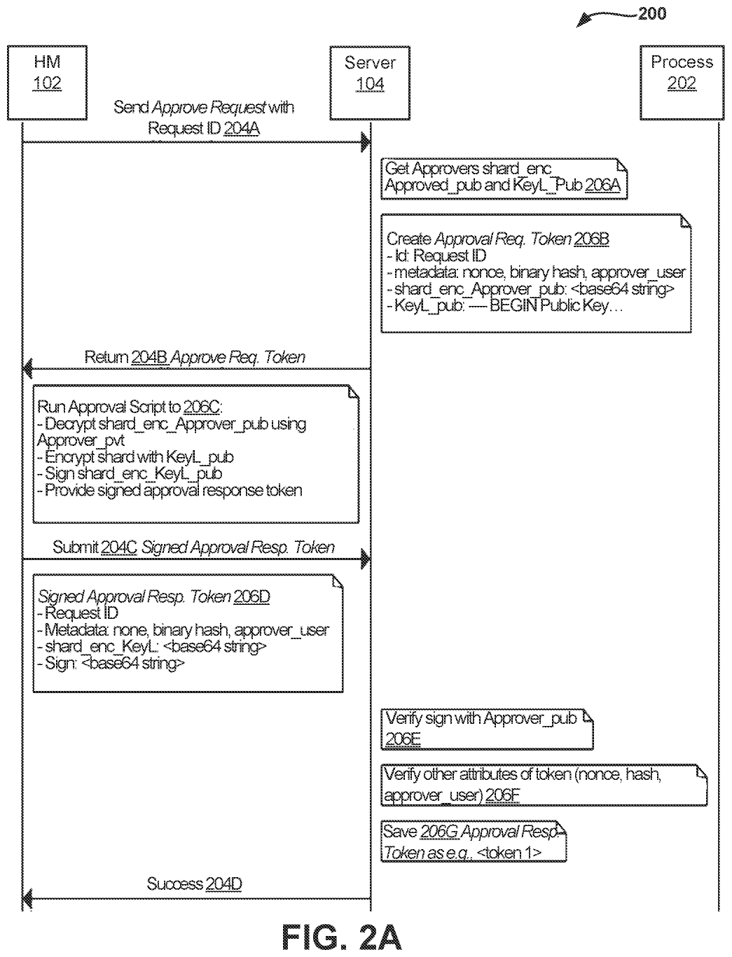

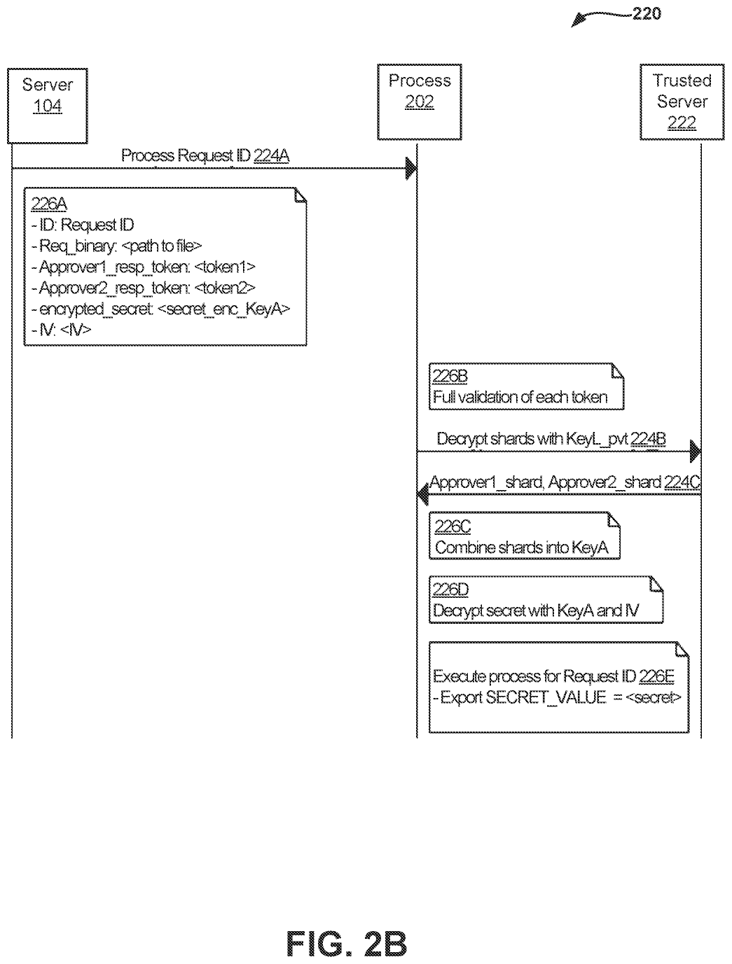

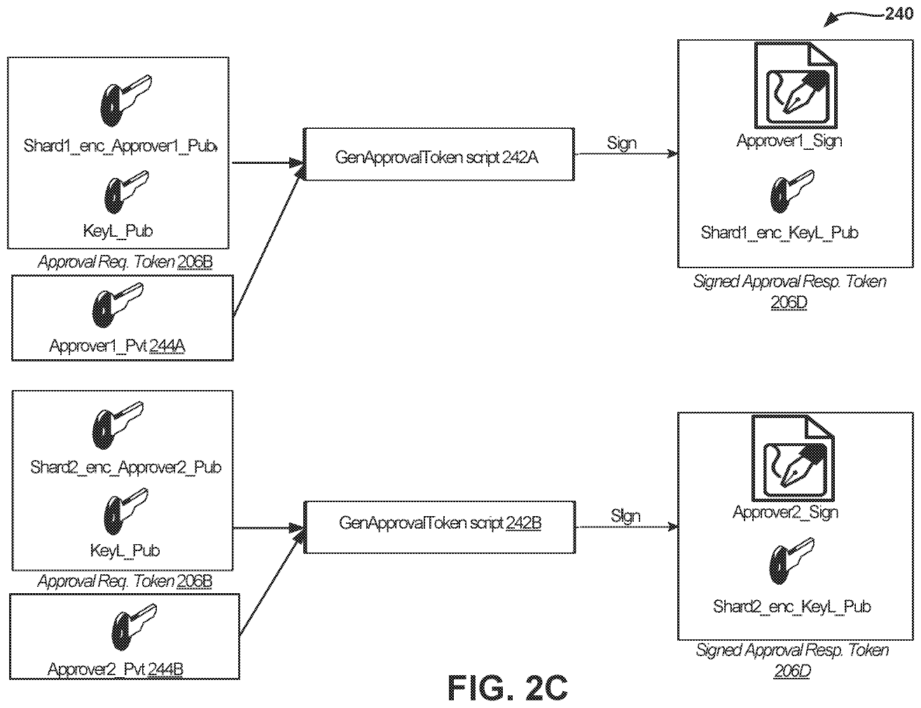

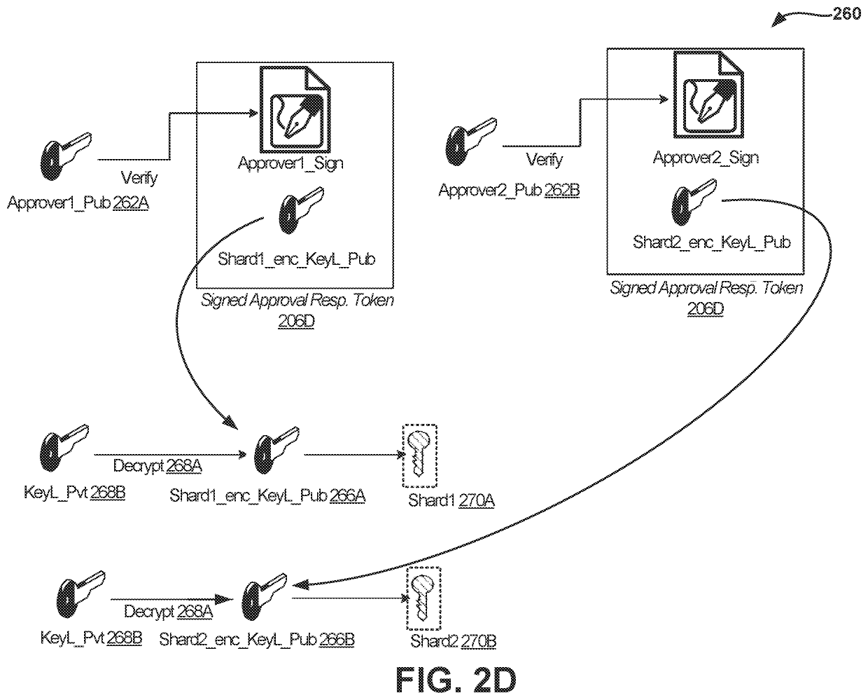

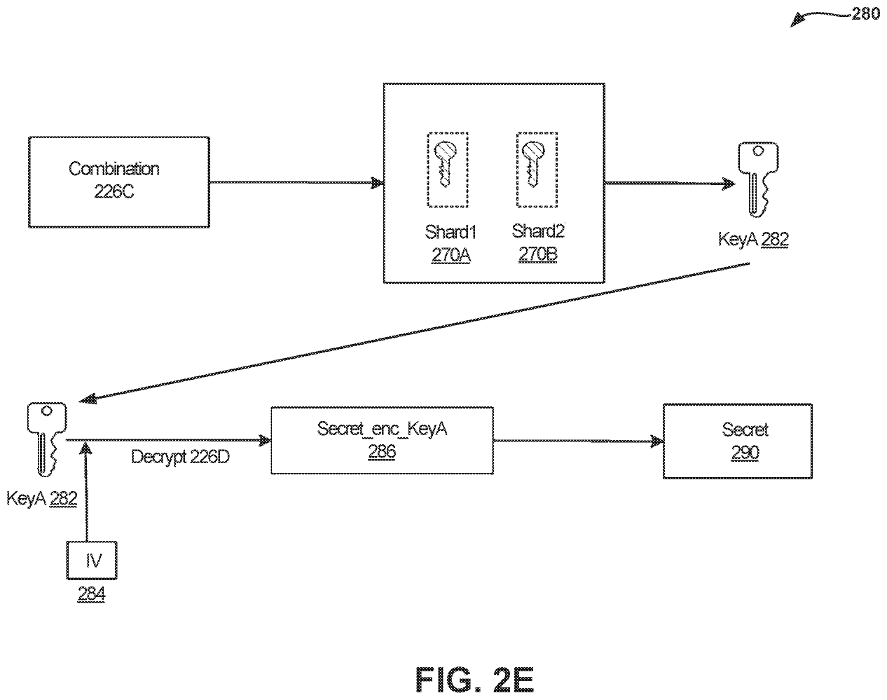

In at least one embodiment, the frontend server may generate approval request tokens when an approver indicates that they want to approve a request. The approval request tokens may include a unique request identifier, a nonce, an approver username, a hash of a request file (if applicable), an approver's encrypted shard, and the KeyL public key, described throughout herein. In at least one embodiment, an approver, on a host machine, may download the approval request token and may run a provided script (such as an automation script that is provided by the frontend server or available at each approver's host machine) to generate an approval response token that is signed and generated in response to the frontend server returning an approval request token to the approval request, for example, as illustrated in FIG. 2A. In at least one embodiment, the script may be used to decrypt approvers' shards with a respective approver's private key (such as an RSA private key) and a passphrase.

In at least one embodiment, the approval sequence includes the script causing re-encryption of each of the shards with the aforementioned KeyL public key for safe transport under the approval response token signed and sent from each of the approver's host machine to the frontend server. Therefore, the approval response token for may be substantially identical in content to the approval request token, except for the decrypted and re-encrypted shards. Further, the script uses the approver's private key to generate the approval response token that is signed and where PSS padding and SHA-256 digest may be used for a hash.

In at least one embodiment, the approval sequence includes the approver uploading their approval response token, as signed, to the frontend server, which may receive different approval response token at different timepoints as and when respective approvers provide them. The frontend server may ensure that all fields within such approval response tokens are correct and may verify each signature using each approver's public key. In at least one embodiment, once the frontend server has collected a threshold or predetermined number of approval request tokens, it can invoke a backend process by dispatching a request that includes the secret_enc_KeyA, the IV, the approver's public keys, and the approval response tokens for the backend process. However, the backend process may be separately invoked or caused as a VM instance or may already exist as a backend server capable of destroying underlying data after the backend process is complete. The request from the frontend server may therefore be sent in a distinct step of the sequence.

In at least one embodiment, the approval sequence includes the backend process verifying that hashes of respective requests match the respective information in the respective approval response tokens (if applicable) and verifying that respective signatures in the respective approval response tokens are associated with the respective approvers' public keys. Once validity is verified, the backend process may use a KeyL private key to decrypt the approvers' encrypted shards and can combine the decrypted shards to yield KeyA. In at least one embodiment, the combination may be performed using Shamir's Secret Sharing Scheme. Further, KeyA and the IV may be then used to decrypt the encrypted secret (secret_enc_KeyA). The secret may be used within a lifetime that is associated with the request. For instance, the secret could be set in an environment variable of a child process that use the secret to fulfill a request from one of the approvers.

In at least one embodiment, the multi-party approval may be used with one active approver representing a human user and with one system-based approver. This is a variation on more than two approvers aspect, by using an extra KeyA shard (shard1) that may be included in a request payload sent to the backend process without requiring a second approver to provide such an encrypted shard. Therefore, the extra KeyA shard may be a KeyL encrypted shard that is prepared in the frontend server and that is provided to the backend server once the single active approver representing the human user provides their KeyL encrypted shard in an approval response token that is verified to its hash matching of the information therein and that is verified to its signature matching a signature therein.

In at least one embodiment, it is possible to adjust approvers to add, remove, change, or update keys or the secret. For example, a request to adjust approvers or the secret may be initiated by an administrator of the frontend server or by an adjust-approvers request from any approver via their host machines to the frontend server. The adjust-approvers request made in this manner may create a special type of request that includes a new approver threshold (or indicates the use of a prior approver threshold) and may include a list of approvers (who have registered public keys with the frontend server). Then, similar to requests to perform a process, approvals may be required from the threshold of existing approvers.

In at least one embodiment, when a frontend server dispatches the adjust-approvers request to the backend process, the frontend server may set a flag indicating that the adjust-approvers request is different than the requests to perform a process. The backend process may execute an approval flow or sequence that is similar with respect to an approval flow or sequence to obtain access to the secret to perform a process. Further, the protection mechanism or scheme described with respect to access the secret to perform a process may be also used for the adjust-approvers request. For example, the same information as the automation scripts associated with the request to perform a process may be returned to the frontend server but may include detail as to the new protection scheme directed to more (or less or changed) approvers or a new secret. The frontend server may update its data store and enforce the new protection mechanism or scheme on subsequent requests.

In at least one embodiment, therefore, the secret, the shards, and certain keys may not be known to any single entity or party, including administrators of the system or the approvers, and may be ephemerally decrypted by the backend process on a per-request basis with the backend process or underlying data deleted or destroyed after each request is completed, whether request to perform a process or adjustment (where deletion may occur after the process or adjustment is completed) or after a threshold amount of time. The system and method herein prevents stockpiling of approvals for unrelated requests and, instead, ties approvals to a single request and file hash.

The system 100 may include one or more host machines 1-N 102 that communicates with at least one frontend server 104 via a network 106. The network 106 may include switches and may be associated with network cards of the host machines or the frontend server 102, 104. Further, the host machines 102, 104 may include respective CPUs 108 and memory 110. The memory 110, 114 may be exclusive to the CPU or a GPU or may be partly accessible as shared memory in each host machine. A first illustrated memory 110 in FIG. 1 may be specific to a CPU may include DRAM and buffer or cache memory of the CPU 108. In at least one embodiment, each approver may be remotely located from other approvers and from the frontend server 104. However, to make their respective public keys available, a registration may be performed to a host machine 102 of each approver and using the frontend server 104 or using a less-formal sharing with one or more administrators of a system associated with multi-party approval in a computer network.

In at least one embodiment, an approver, on a host machine 102, may download the approval request token and may run a provided script (such as an automation script that is provided by the frontend server 104 or available at each approver's host machine 102) to generate an approval response token in response to the frontend server returning an approval request token, for example, as illustrated in FIG. 2A. In at least one embodiment, a request to perform an application process may be provided by an approver using a respective host machine 102. The application process may require access to the secret and may be on a different backend server than the application process. In at least one embodiment, a request to adjust approvers or the secret may be initiated by an administrator of the frontend server 104 or by an adjust-approvers request from any approver via their host machines 102 to the frontend server 104.

FIG. 2A illustrates part 200 of a sequence for protecting secrets with multi-party approval in a computer network, according to at least one embodiment. The computer network may include a server 104, such as a frontend server, and at least one process 202, such as a backend process. In at least one embodiment, the backend process 202 may be provided as a physical server or service or may be provided as a virtual instance (such as a virtual machine) deployed on a cloud or on the physical server or service. The server 104 may be a feature-rich frontend server or a specific frontend server. An approver associated with a host machine 102 may send 204A an Approve Request with a request identifier (Request ID) to a frontend server 104 to access a secret or to perform an application process that is distinct from the process 202 that requires access to the secret.

The frontend server 104 gets 206A the approvers encrypted shard (shard_enc) and a public key (KeyL_Pub) associated therewith and associated with a trusted server (such as a trusted server 222 from FIG. 2B). For example, the frontend server 104 may access an associated storage to get 206A this information. The frontend server 104 may store each approver's shard as encrypted under a respective public key (Approver_Pub) that provides a respective the encrypted shard, such as shard_enc_Approver_Pub. The frontend server 104 creates 206B an Approval Request Token that may include the Request ID, metadata (such as a nonce, a binary hash, and an approver user, username, or identifier), the further encrypted shard (shard_enc_Approver_Pub), and the public key (KeyL_Pub) associated with a trusted server.

The frontend server 104 returns 204B an Approval Request Tokens to respective approvers, such as to the same or a different host machine 102 associated with the respective approvers. For example, a host machine 102 associated with the sending 204A step may be different than a host machine 102 associated with the return 204B step. Further, even if illustrated in the singular, a skilled artisan would recognize that approaches herein may be used with two or more physical approvers and may be provided in the plural, such as the multiple Approval Request Tokens that may be specific to each of the two or more physical approvers.

In at least one embodiment, an approval script may be provided at a same or a different time from a frontend server 104 to each host machine 102 participating in the multi-party approval in the computer network. In at least one embodiment, the approval script may be provided to the host machine 102 independently from the frontend server 104. Each host machine may run 206C its approval script to perform functions on the information within the Approval Request Token. The functions may include to decrypt the encrypted shard (shard_enc_Approver_Pub) using each approver's private key (Approver_Pvt) corresponding to each approver's public key (Approver_Pub) used in the frontend server 104 to store the encrypted shard.

In at least one embodiment, the functions run 206C may include encrypting the decrypted shard with the public key (KeyL_Pub) associated with a trusted server, as received in the Approval Request Token. This provides a new encrypted shard (shard_enc_KeyL). Another function run 206C may include creation of an Approval Response Token. A further function run 206C, in each host machine, may include to sign the Approval Response Token using each approver's private key (Approver_Pvt). Yet another function includes providing or saving the Signed Approval Response Token within the host machine. In at least one embodiment, a hash, such as a base64 string, may be generated for each new encrypted shard (shard_enc_KeyL). The In at least one embodiment, the hash may be signed using a respective approver's private key (Approver_Pvt). Further, each of the host machines of an approver submits 204C its Signed Approval Response Token 206D to the frontend server 104. The Signed Approval Response Token 206D includes the Request ID, the metadata (as previously received in the Approval Request Token 206B), the new encrypted shard (shard_enc_KeyL), and the signature.

In at least one embodiment, the frontend server 104 may receive each Signed Approval Response Token 206D from each host machine 102 or approver. In at least one embodiment, this may be from different approvers using the same host machine 102. For example, each approver on a same host machine may use different virtual machines (VMs) to provide a request, to receive an Approval Request Token, and to provide a Signed Approval Response Token. The frontend server 104 may verify 206E each signature of each Signed Approval Response Token 206D with a respective approver's private key (Approver_Pvt). Other attributes therein, such as the metadata (the nonce, the hash, and the approver's user, username, or identifier) may be also verified 206F to ensure that no information has changed.

In at least one embodiment, the frontend server 104 accumulates or saves 206G encrypted shards (multiple shard_enc_KeyL) that are received in the frontend server 104 at different timepoints from different approvers or different host machines 102. For example, the frontend server 104 accumulates each of the Signed Approval Response Token 206D, representing accumulation of the encrypted shards therein. In at least one embodiment, the frontend server 104 saves the Signed Approval Response Tokens received at different timepoints as token1, token2 . . . tokenN. In at least one embodiment, following the accumulation of one Signed Approval Response Token 206D, the frontend server may return a success 204D indication or message to the host machine 102 or an approver associated therewith.

FIG. 2B illustrates a further part 220 of a sequence for protecting secrets with multi-party approval in a computer network, according to at least one embodiment. In at least one embodiment, the further part 220 follows from the part 200 of the sequence in FIG. 2A. In at least one embodiment, the frontend server 104 may enable a backend process 202 upon accumulating a predetermined number of the encrypted shards. In at least one embodiment, the frontend server 104 invokes the backend process 202 on a virtual instance (including a virtual machine) and which may be destroyed (or the underlying data deleted) upon completing its tasks. In at least one embodiment, the frontend server 104 may enable a backend process 202 that is already associated with an underlying server or service upon accumulating a predetermined number of the encrypted shards.

In at least one embodiment, the frontend server 104 may enable a backend process 202 to process 224A a request 226A by its Request ID. In at least one embodiment, a request to the backend process 202 may be a distinct step from invoking or requesting a backend process 202 to execute on a server or service. In at least one embodiment, however, the request to the backend process 202 may cause the invoking or requesting of a backend process 202 to execute on a server or service. In at least one embodiment, the backend process 202 is remote from the frontend server 104. The request 226A to the backend process 202 may include the Request ID, a request binary (Req_binary or reference path to the request binary), each of the approver's tokens (such as Approver1_resp_token: <token1>, Approver2_resp_token: <token2>), and an encrypted secret (encrypted_secret: <secret_enc_KeyA>) that is maintained at the frontend server 104. Further, the request 226A may include an initialization vector (IV: <IV>) that is associated with the encrypted secret.

In at least one embodiment, the backend process 202 may perform a full validation 226B of the information in the request 226A, including in each of the tokens (token1 . . . tokenN). This may include verifying at least the metadata associated with the tokens. In at least one embodiment, the backend process 202 may communicate 224B, 224C with a trusted server 222 to which an association may be created at the time of communication or to which an association may be provided beforehand. In at least one embodiment, the communication 224B, 224C includes the shards (multiple shard_enc_KeyL). The trusted server 222 retains a private key (KeyL_Pvt) version of the public key (KeyL_Pub) previously provided to the frontend server 104 and used as detailed in FIG. 2A. In at least one embodiment, the backend process 202 is enabled to communicate 224B, 224C with a trusted server 222 to cause decryption 224B of the shards. For example, the trusted server 222 performs a decryption 224B of the shards (shard_enc_KeyL) provided from the backend process 202 using a private key (KeyL_Pvt).

In at least one embodiment, the trusted server 222 returns 224C the decrypted shards (Approver1_shard1, Approver1_shard2) to the backend process 202. In at least one embodiment, the backend process 202 performs a combination 226C on the shards (Approver1_shard1, Approver1_shard2) to provide KeyA. The backend process 202 decrypts 226D the encrypted secret (encrypted_secret: <secret_enc_KeyA>) using KeyA and the previously provided initiation vector (IV: <IV>) to provide access to the secret. In at least one embodiment, therefore, the decryption 224B and the combination 226C that is performed on the encrypted shards provide a key (such as KeyA) to be used to decrypt 226D an encrypted version of the secret as part of the access to the secret.

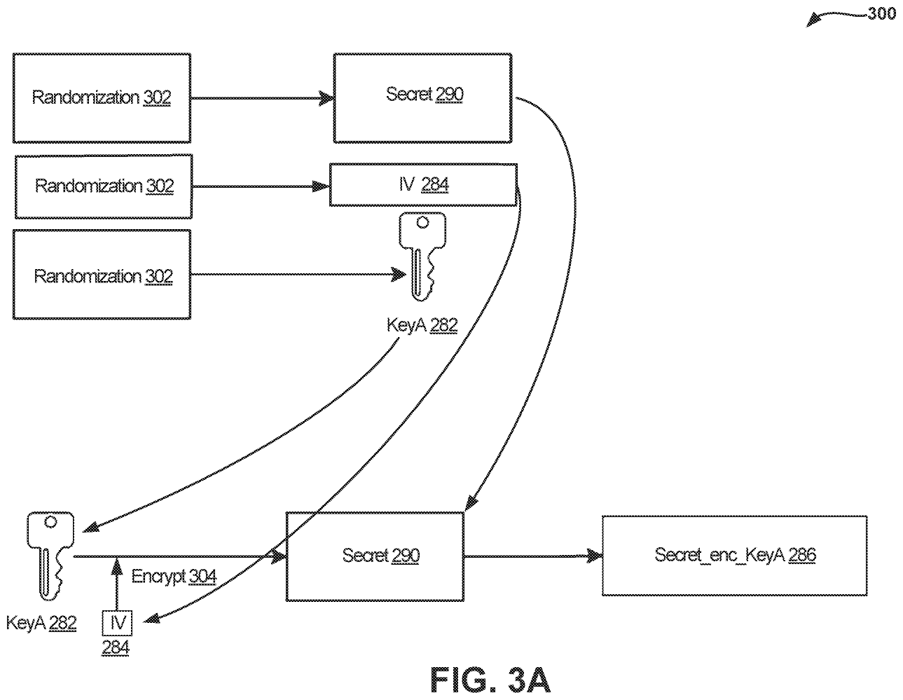

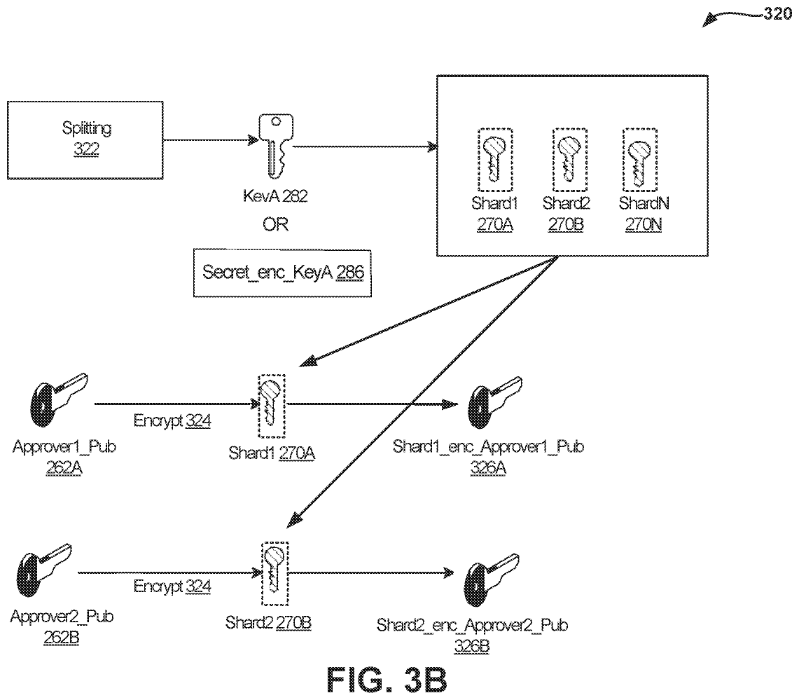

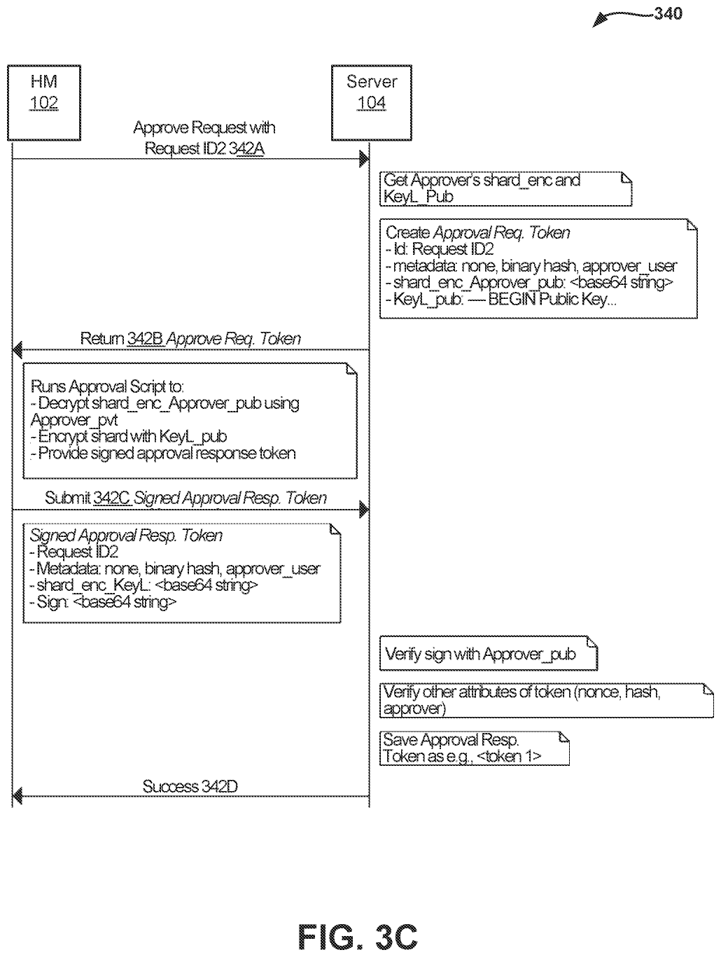

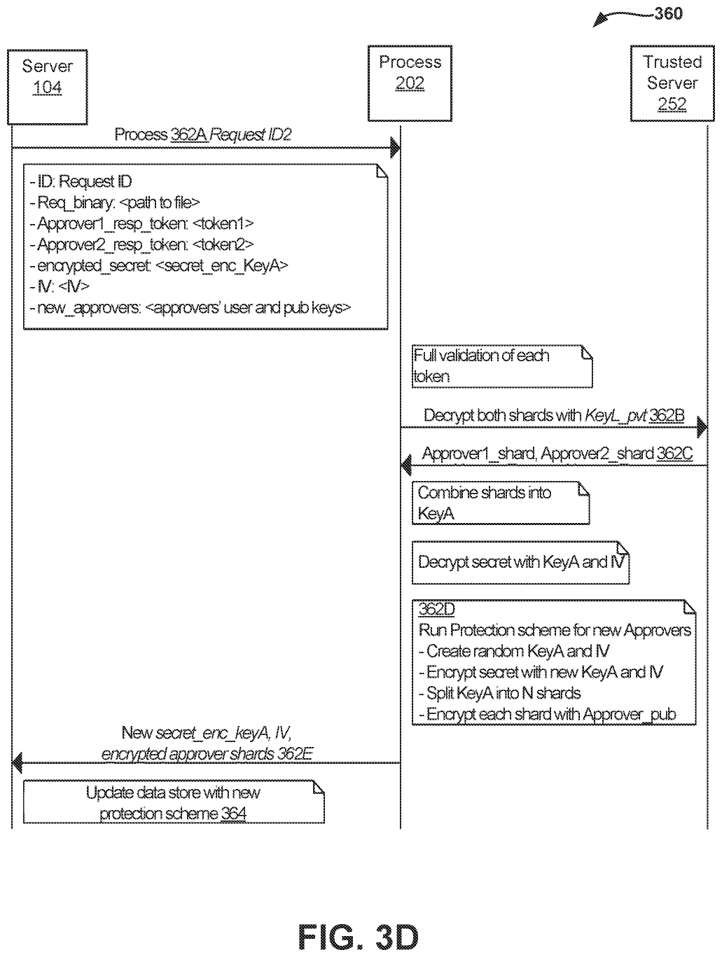

In at least one embodiment, the secret itself may be provided as the encrypted shards. For example, the encrypted shards include parts of the secret as encrypted under a KeyA or a KeyL_Pub and may not be parts of a KeyA that is used to decrypt an encrypted version of the secret. This may be understood using FIG. 3B in which the splitting 322 may be applied to the key (as illustrated) or may be applied to an encrypted version of the secret (encrypted under KeyA 286 or encrypted under KeyL_Pub, as an alternative). Then, each approval request token 206B may be associated with a KeyL_Pub (such as by virtue of the secret being encrypted by KeyL_Pub and then split into KeyL_Pub-encrypted shards) and may be further encrypted by each approver's public key (Approver_Pub) when sent to each approver. Each signed approval response token 206D may also be associated with a respective version of the KeyL_Pub-encrypted shard after decryption by each approver's private key (Approver_Pvt) and after signing that is associated with each approver's private key (Approver_Pvt).

In at least one embodiment, under such an approach, a further encrypted shard that may be a root or required encrypted shard (also encrypted under KeyL_Pub or KeyA) may be retained in the frontend server 104 and that may not be shared to an approver. In at least one embodiment, the communication from the backend process 202 to the trusted server 222 may include all such KeyL_Pub (or KeyA)-encrypted shards and the IV, as accumulated at different timepoints in the frontend server 104 and including the root or required encrypted shard (if one exists). The trusted server 222 may return decrypted shards by decrypting the encrypted shards (encrypted under KeyL_Pub) using a KeyL_Pvt key. The backend process 202 may perform decryption and combination of all the shards to provide access to the secret, such as by revealing the secret, to the process, to a different process referred to herein as an application process, or to a backend server that requires access to the secret. For example, the backend process 202 may combine all the split KeyL_Pub-encrypted shards to provide the KeyL_Pub-encrypted secret. Then the backend process 202, together with the trusted server 222, may perform the decryption using the KeyL_Pvt key and any IVs to provide access to the secret.

In at least one embodiment, instead of KeyL_Pub and KeyL_Pvt keys in an asymmetric encryption of the secret, a symmetric KeyA from a trusted server 222 may be used so that each approval request token 206B may be associated with a KeyA (such as by virtue of the secret being encrypted by KeyA and then split into KeyA-encrypted shards). The remaining aspects, as described with the split KeyL_Pub-encrypted shards, may be applied here. In this embodiment, however, it is possible to change the KeyA without interacting with an Approver as the KeyA is a symmetry encryption of the secret. This allows KeyA to be cycled whereas the use of the asymmetric encryption of the secret, where the encrypted shards include the split KeyL_Pub-encrypted shards, may not allow cycling of the KeyL_Pub and KeyL_Pvt keys without interacting with an Approver.

In at least one embodiment, KeyA is therefore used with an IV to decrypt 226D the encrypted version of the secret. In at least one embodiment, with the secret accessible, the backend process 202 may execute 226E an application process that is associated with the Request ID. In at least one embodiment, the application process executed 226E may include export a value (such as a SECRET_VALUE=<secret>) to another backend process or server or to a different entity that is associated with the Request ID.

In at least one embodiment, while the description with respect to FIGS. 2A, 2B may be multi-party approval in a computer network that covers two active approvers representing two human users, it is also possible to cover one active approver representing a human user and one system-based approver using aspects herein. For example, one encrypted shard may be retained on the frontend server 104 and may be encrypted under the KeyL_Pub key and that may be provided in the communication with the backend process 202, and subsequently for decryption by the trusted server 222 as described in the two active approvers approach. In the system-based approver, therefore, an extra shard (such as shard1 in one or more FIGS. herein) that has no designated approver may be returned in the request from the frontend server 104 to a backend process 202 to enable access to the secret. The encrypted shards may be stored in a data store that is available to the frontend server 104.

FIG. 2C illustrates a part 240 of a key flow for protecting secrets with multi-party approval in a computer network, according to at least one embodiment. The key flow describes, in part, the provision of an Approval Request Token and of an Approval Response Token. In at least one embodiment, a script (such as a GenApprovalToken script 242A; 242B) may be provided in one or more of a frontend server 104 or each host machine 102 participating in the multi-party approval in the computer network. In at least one embodiment, the script 242A; 242B may be used to generate at least the Signed Approval Response Token 206D.

In at least one embodiment, a respective script 242A; 242B on a respective host machine 102 may use an approver's private key (such as Approver1_Pvt or Approver2_Pvt) 244A; 244B to first decrypt the respective encrypted shards (shard1_enc_Approver1_Pub and shard2_enc_Approver2_Pub) of the respective Approval Request Token 204A. The script 242A; 242B on the respective host machine 102 may then use the provide trusted server public key (such as KeyL_Pub) to encrypt the respective decrypted shards to provide these as shard1_enc_KeyL_Pub and shard2 enc_KeyL_Pub) in a respective Approval Response Token that is then signed to provide Signed Approval Response Token 206D. In at least one embodiment, the contents to be in the respective Signed Approval Response Token 206D may be signed using the Approver's private key 244A; 244B to provide the respective Signed Approval Response Token 206D.

FIG. 2D illustrates a further part 260 of a key flow for protecting secrets with multi-party approval in a computer network, according to at least one embodiment. This further part 260 may be associated and follow from the part 240 of the key flow described in FIG. 2C. In at least one embodiment, at a frontend server 104, each Signed Approval Response Token 206D, as submitted by a host machine 102 or an approver, may be received. Each Signed Approval Response Token 206D may be verified using each approver's public key 262A, 262B to ensure that its contents have not changed between the host machine 102 or approver and the frontend server 104. The frontend server 104 may then enable a backend process 202 that may communicate with a trusted server 222 to perform decryption. For example, the respective shards (shard1_enc_KeyL_Pub and shard2_enc_KeyL_Pub) 266A, 266B in a respective Signed Approval Response Token 206D may be decrypted 268A using a trusted server private key (KeyL_Pvt) 268B of the trusted server 222, as detailed in FIG. 2B. The backend process 202 may then have the shards 270A, B from the decryption.

FIG. 2E illustrates yet another part 280 of a key flow for protecting secrets with multi-party approval in a computer network, according to at least one embodiment. This further part 280 may be associated and follow from the part 260 of the key flow described in FIG. 2D. In at least one embodiment, a combination 226C of the shards 270A, B may be performed using Shamir's Secret Sharing Scheme. However, a skilled artisan would appreciate that other schemes for combinations of shards may be used. The combination 226D generates or provides the KeyA 284 previously used to encrypt the secret. Further, KeyA 284 and an IV 284 may be then used to decrypt 226D the encrypted secret (secret_enc_KeyA) 286. A secret 290 generated or provided after the decryption 226D may be used within a lifetime that is associated with the request. For instance, the secret could be set in an environment variable of a child process that use the secret to fulfill a request from one of the approvers.

FIG. 3A illustrates a part 300 of a key flow for creating a secret and encrypted shards to be used for protecting secrets with multi-party approval in a computer network, according to at least one embodiment. In at least one embodiment, one or more randomization modules 302 may be used to generate the initialization vector 284, the secret 290, and a KeyA 284. In at least one embodiment, the randomization modules 302 use a randomizer algorithm that would be understood to a skilled artisan reviewing the disclosure herein. Further, the part 300 of the key flow herein may be also used to update, change, or modify one or more of the IV, secret, the KeyA, or the number of shards required according to a predetermined number or threshold of approvers required to enable the multi-party approval in a computer network. In at least one embodiment, the KeyA 284 may be used to encrypt 304 (such as, by an AES-256-CBC encryption) the secret 290 to provide the encrypted secret (Secret_enc_KeyA) 286. In at least one embodiment, one or more of the part 300 of the key flow may be performed in a frontend server 202 or a backend process 202.

FIG. 3B illustrates yet another part 320 of a key flow for creating a secret and encrypted shards to be used for protecting secrets with multi-party approval in a computer network, according to at least one embodiment. This further part 320 may be associated and follow from the part 300 of the key flow described in FIG. 3A. In at least one embodiment, a splitting 322 of KeyA 284 may be performed using a Shamir's Secret Sharing Scheme. However, a skilled artisan would appreciate that other schemes for splitting of keys may be used. The splitting aspect herein generates the shards, 270A-N.

In at least one embodiment, each of the shards 270A-N, such as shard1 270A and shard2 270B, may be encrypted 324 using a respective approver's public key, such as Approver1_Pub 262A and Approver2_Pub 262B. The resulting encrypted shards (such as shard1_enc_Approver1_Pub and shard2_enc_Approver2_Pub) 326A, 326B may be provided to the frontend server 202 for storage till requested by an approver as described in FIGS. 2A and 2C. In at least one embodiment, therefore, multi-party approval in computer networks includes using one or more randomizers to provide the secret and the key, encrypting the secret with at least the key to provide the encrypted version of the secret, and enabling splitting and encryption of the key to provide a version of the encrypted shards, where the splitting is performed according to the predetermined number of the encrypted shards. As the shards are approver public key-encrypted, these need to be re-encrypted using a third-party public key (such as KeyL_pub) prior to accumulation in the frontend server 104 to provide the encrypted shards.

In at least one embodiment, following from the example encrypting 324, individual ones of the encrypted shards are encrypted using individual public keys associated with individual different approvers. In addition, the individual ones of the public keys may be associated with respective private keys that belong to respective different approvers. In at least one embodiment, when it determined to update, change, or modify one or more of the secret, the KeyA, or the number of shards, the procedure to access the secret in FIGS. 2A, 2B and in FIGS. 2C-2E may be performed. Then the procedure in FIGS. 3A, 3B may be performed according to the update, change, or modification required to provide a new secret, a new KeyA, or a new number of shards required to a predetermined number or threshold of approvers required to enable the multi-party approval in a computer network. This is further detailed in FIGS. 3C, 3D.

FIG. 3C illustrates a part 340 of a sequence for adjusting approvers to be used for protecting secrets with multi-party approval in a computer network, according to at least one embodiment. In at least one embodiment, as in the part 200 of the sequence of FIG. 2A, an approver associated with a host machine 102 may send 342A an Approve Request with a Request ID2 to a frontend server 104 to access a secret or to perform the adjusting approvers approach that requires access to the secret. Further, as this request is distinct from the request with the Request ID of the part 200 of the sequence of FIG. 2A, this request includes a different identifier, Request ID2.

Like in the part 200 of the sequence of FIG. 2A, the frontend server 104 gets the approvers encrypted shard (shard_enc) and a public key (KeyL_Pub) associated therewith and associated with a trusted server (such as a trusted server 222 from FIG. 2B). For example, the frontend server 104 may access an associated storage to get this information. The frontend server 104 may store each approver's shard as encrypted under a respective public key (Approver_Pub) that provides a respective the encrypted shard, such as shard_enc_Approver_Pub. The frontend server 104 creates an Approval Request Token that may include the Request ID2, metadata (such as a nonce, a binary hash, and an approver user, username, or identifier), the further encrypted shard (shard_enc_Approver_Pub), and the public key (KeyL_Pub) associated with a trusted server.

Similarly, like in the part 200 of the sequence of FIG. 2A, the frontend server 104 returns 342B an Approval Request Tokens to respective approvers, such as to the same or a different host machine 102 associated with the respective approvers. For example, a host machine 102 associated with the sending 204A step may be different than a host machine 102 associated with the return 342B step. Further, even if illustrated in the singular, a skilled artisan would recognize that approaches herein may be used with two or more physical approvers and may be provided in the plural, such as the multiple Approval Request Tokens that may be specific to each of the two or more physical approvers.

In at least one embodiment, an approval script may be provided at a same or a different time from a frontend server 104 to each host machine 102 participating in the multi-party approval in the computer network. In at least one embodiment, the approval script may be provided to the host machine 102 independently from the frontend server 104. Each host machine may run its approval script to perform functions on the information within the Approval Request Token. The functions may include to decrypt the encrypted shard (shard_enc_Approver_Pub) using each approver's private key (Approver_Pvt) corresponding to each approver's public key (Approver_Pub) used in the frontend server 104 to store the encrypted shard.

In at least one embodiment, the functions run may include encrypting the decrypted shard with the public key (KeyL_Pub) associated with a trusted server, as received in the Approval Request Token. This provides a new encrypted shard (shard_enc_KeyL). Another function run may include creation of an Approval Response Token. A further function run, in each host machine, may include to sign the Approval Response Token using each approver's private key (Approver_Pvt). Yet another function includes providing or saving the Signed Approval Response Token within the host machine. In at least one embodiment, a hash, such as a base64 string, may be generated for each new encrypted shard (shard_enc_KeyL). The In at least one embodiment, the hash may be signed using a respective approver's private key (Approver_Pvt). Further, like in the part 200 of the sequence of FIG. 2A, each of the host machines of an approver submits 342C its Signed Approval Response Token to the frontend server 104. The Signed Approval Response Token includes the Request ID2, the metadata (as previously received in the Approval Request Token), the new encrypted shard (shard_enc_KeyL), and the signature.

In at least one embodiment, the frontend server 104 may receive each Signed Approval Response Token from each host machine 102 or approver. In at least one embodiment, this may be from different approvers using the same host machine 102. Like in the part 200 of the sequence of FIG. 2A, the frontend server 104 may verify each signature of each Signed Approval Response Token with a respective approver's private key (Approver_Pvt). Other attributes therein, such as the metadata (the nonce, the hash, and the approver's user, username, or identifier) may be also verified to ensure that no information has changed.

In at least one embodiment, aspects in the part 200 of the sequence of FIG. 2A and the part 340 in FIG. 3C therefore include receiving a request 204A, 342A from a host machine 102 for an application process requiring the access to the secret or for access to the secret. The aspects include providing 204B 342B an approval request token (such as the illustrated Approval Request Token) having a third-party public key (such as KeyL_Pub) and a version of an encrypted shard. As illustrated in FIGS. 2A, 3C, the version of one of the encrypted shard includes an approver key-encrypted shard (such as a shard_enc_Approver_pub) that is to be decrypted by an approver private key (such as a Approver_pvt) and that is to be re-encrypted using the third-party public key to provide the encrypted shard (such as shard_enc_KeyL) that is to be accumulated by the frontend server 104. Further, aspects in the part 200 of the sequence of FIG. 2A and the part 340 in FIG. 3C also include receiving from the host machine 102 a response token (such as the illustrated Signed Approval Response Token) that has within it the encrypted shard (such as shard_enc_KeyL).

In at least one embodiment, like in the part 200 of the sequence of FIG. 2A, the frontend server 104 accumulates or saves encrypted shards (multiple shard_enc_KeyL) that are received in the frontend server 104 at different timepoints from different approvers or different host machines 102. For example, the frontend server 104 accumulates each of the Signed Approval Response Token, representing accumulation of the encrypted shards therein. In at least one embodiment, the frontend server 104 saves the Signed Approval Response Tokens received at different timepoints as token1, token2 . . . tokenN. In at least one embodiment, following the accumulation of one Signed Approval Response Token, the frontend server may return a success 342D indication or message to the host machine 102 or an approver associated therewith.

FIG. 3D illustrates yet another part 360 of a sequence for adjusting approvers to be used for protecting secrets with multi-party approval in a computer network, according to at least one embodiment. This further part 360 may be associated and follow from the part 340 of the sequence for adjusting approvers described in FIG. 3C. One or more aspects in this part 360 may be like in the part 220 of the sequence of FIG. 2B. For example, here too, the frontend server 104 may enable a backend process 202 upon accumulating a predetermined number of the encrypted shards. In at least one embodiment, the frontend server 104 invokes the backend process 202 on a virtual instance (including a virtual machine) and which may be destroyed (or the underlying data deleted) upon completing its tasks. In at least one embodiment, the frontend server 104 may enable a backend process 202 that is already associated with an underlying server or service upon accumulating a predetermined number of the encrypted shards.

In at least one embodiment, the frontend server 104 may enable a backend process 202 by a process 362A request using a request identifier (Request ID2). In at least one embodiment, a request to the backend process 202 may be a distinct step from invoking or requesting a backend process 202 to execute on a server or service. In at least one embodiment, however, the request to the backend process 202 may cause the invoking or requesting of a backend process 202 to execute on a server or service. In at least one embodiment, the backend process 202 is remote from the frontend server 104 and may be a distinct server or may be on a distinct server than the frontend server 104. The request 362A to the backend process 202 may include the Request ID2, a request binary (Req_binary or reference path to the request binary), each of the approver's tokens (such as Approver1_resp_token: <token1>, Approver2_resp_token: <token2>), and an encrypted secret (encrypted_secret: <secret_enc_KeyA>) that is maintained at the frontend server 104. Further, the request may include an initialization vector (IV: <IV>) that is associated with the encrypted_secret.

In at least one embodiment, different than the part 220 of the sequence of FIG. 2B, the request 362A, in this part 360, to the backend process may include the change requested to the multi-party approval, including to update, change, or modify one or more of the secret, the KeyA, or the number of shards. For example, the request 362A may include the number of new shards as reflected by the number of new approvers (such as new_approvers: <approvers' user and pub keys>).

In at least one embodiment, the backend process 202 may perform a full validation of the information in the request 362A like in the part 220 of the sequence of FIG. 2B. This may include verification in each of the tokens (token1 . . . tokenN) and may include verifying at least the metadata associated with the tokens. In at least one embodiment, the backend process 202 may communicate 362B, 362C with a trusted server 222 to which an association may be created at the time of communication or to which an association may be provided beforehand. In at least one embodiment, the communication 362B, 362C includes the shards (multiple shard_enc_KeyL). The trusted server 222 retains a private key (KeyL_Pvt) version of the public key (KeyL_Pub) previously provided to the frontend server 104 and used as detailed in FIG. 3C. In at least one embodiment, the backend process 202 is enabled to communicate 362B, 362C with a trusted server 222 to cause decryption 362B of the shards. For example, the trusted server 222 performs a decryption 362B of the shards (shard_enc_KeyL) provided from the backend process 202 using a private key (KeyL_Pvt).

In at least one embodiment, like in the part 220 of the sequence of FIG. 2B, the trusted server 222 returns 362C the decrypted shards (Approver1_shard1, Approver1_shard2) to the backend process 202. In at least one embodiment, the backend process 202 performs a combination on the shards (Approver1_shard1, Approver1_shard2) to provide KeyA. The backend process 202 decrypts the encrypted secret (encrypted_secret: <secret_enc_KeyA>) using KeyA and the previously provided initiation vector (IV: <IV>) to provide access to the secret.

In at least one embodiment, in the part 360, the secret itself may be provided as the encrypted shards. Then, each token in the request 362A (and from each approver) may be associated with a respective one of the encrypted shards (encrypted under KeyL_Pub). A further encrypted shard that may be a root or required encrypted shard associated with a separate key (such as KeyA). In at least one embodiment, the communication from the backend process 202 to the trusted server 222 may include the all the encrypted shards and the IV but may not include the root or required encrypted shard. The trusted server 222 may return decrypted shards by decrypting the shards using a KeyL_Pyt key. The trusted server may also provide KeyA to the backend process 202. The backend process 202 can decrypt the root or required encrypted shard using KeyA and the IV and combines the shards to provide access to the secret.

In at least one embodiment, with the secret accessible, the backend process 202 may execute or run 362D an application process, where this specific application process is associated with the Request ID2. In at least one embodiment, the application process executed 362D may include to update, change, or modify one or more of the secret, the KeyA, or the number of shards. For example, the application process executed 362D may create a new random KeyA and IV, such as in FIG. 3A. The application process executed 362D may also create a new secret. The application process executed 362D may encrypt the secret or a new secret with the new KeyA and the new IV. The application process executed 362D may split the new encrypted KeyA into the new number of shards requested. The application process executed 362D may encrypt each shard with the provided approvers' public keys (Approver_pub) from the request 362A in the Request ID2.

In at least one embodiment, the new secret as encrypted by new KeyA, the new IV, and the new number of encrypted shards may be provided 362E to be retained on the frontend server 104. This may cause the frontend server 104 to update its data store with a new protection scheme reflected by one or more of the new KeyA, the new IV, and the new number of encrypted shards. Then access to the new secret may be performed in a manner as described with respect to one or more of FIGS. 2A-2E. In the system-based approver, an extra shard (such as shard1 in one or more FIGS. herein) that has no designated approver may be retained in the frontend server 104 to enable access to the secret using one human-based approver in the multi-party approval. The encrypted shards may be stored in a data store that is available to the frontend server 104.

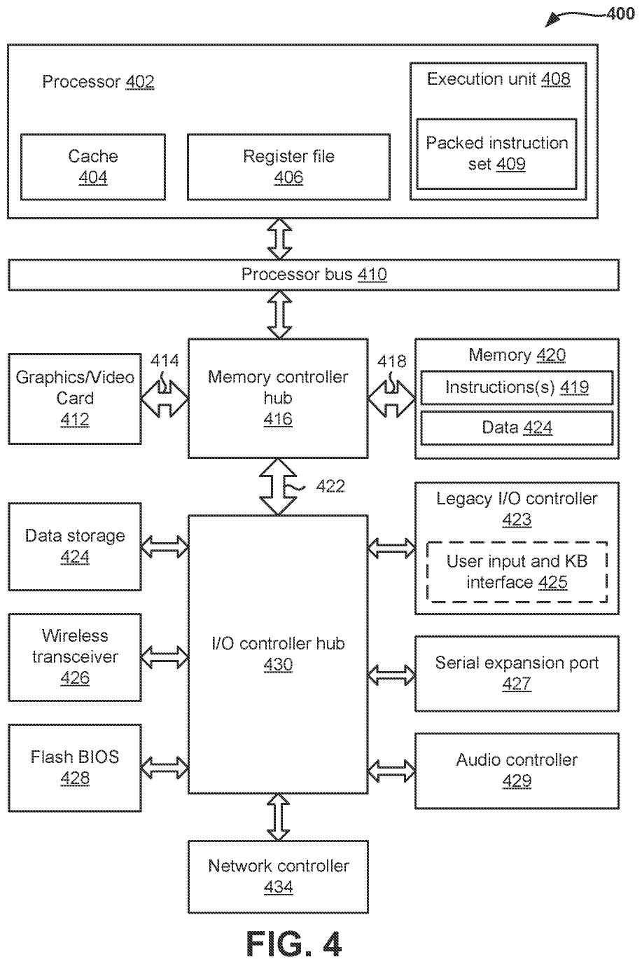

FIG. 4 illustrates computer and processor aspects 400 of a system for protecting secrets with multi-party approval in a computer network, according to at least one embodiment. In at least one embodiment, the computer and processor aspects 400 may be part of one or more of (or all of) a host machine 102, a server 104, or a process 202 (or a different server). The computer and processor aspects 400 may be performed by one or more processors that include a system-on-a-chip (SOC) or some combination thereof formed with a processor that may include execution units to execute an instruction, according to at least one embodiment. Such one or more processors may include CPUs and GPUs. Further, the computer and processor aspects may be within one or more of the controller 408 or the adapter 406.

In at least one embodiment, the computer and processor aspects 400 may include, without limitation, a component, such as a processor 402 to employ execution units including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3D and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer system 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

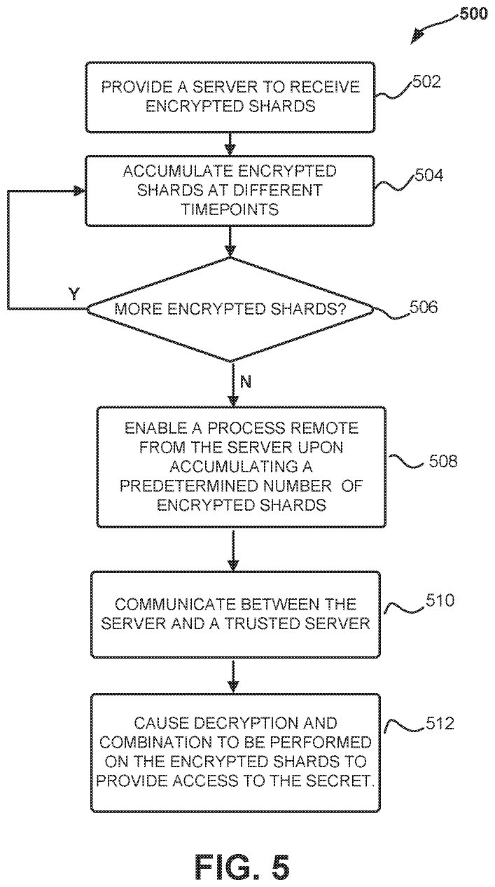

FIG. 5 illustrates a process flow or method 500 for a system for protecting secrets with multi-party approval in a computer network, according to at least one embodiment. The process flow or method 500 includes providing (502) a server, such as a frontend server, to accumulate (504) encrypted shards that are received in the frontend server at different timepoints. The encrypted shards may be associated with a secret. The process flow or method 500 includes a verification (506) against a predetermined number of encrypted shards required to process a request for an application process or for access to the secret from an approver, for instance. The process flow or method 500 includes enabling (508), using the server, a process upon accumulating a predetermined number of the encrypted shards. The process may be a backend process and is remote from the server. The process flow or method 500 includes communicating (510), between the process and a trusted server, to cause (512) decryption and combination to be performed on the encrypted shards to provide access to the secret.

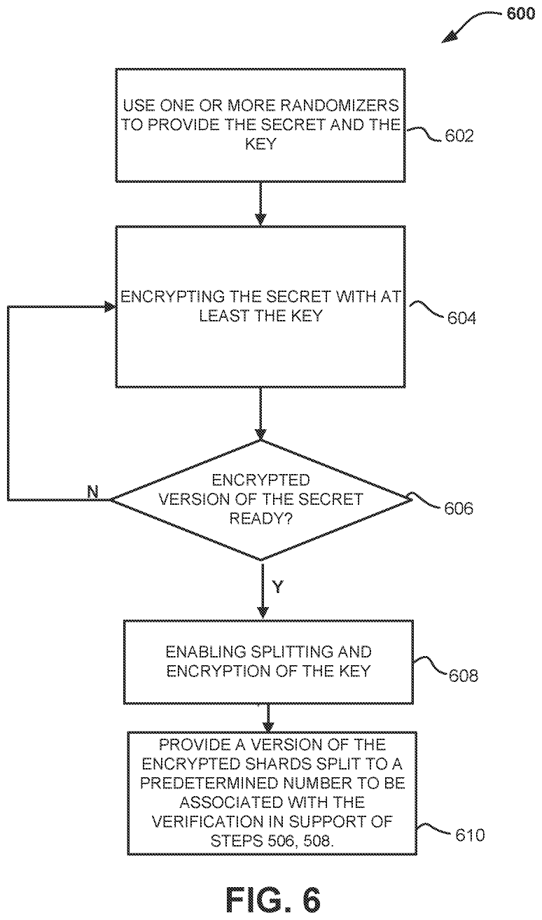

FIG. 6 illustrates yet another process flow or method 600 for a system associated with protecting secrets with multi-party approval in a computer network, according to at least one embodiment. In at least one embodiment, the process flow or method 600 includes using (602) one or more randomizers to provide the secret and the key. The process flow or method 600 includes encrypting (604) the secret with at least the key to provide the encrypted version of the secret. A verification (606) may be performed that the encrypted version of the secret is ready for further processing. The process flow or method 500 includes enabling (608) splitting and encryption of the key to provide (610) a version of the encrypted shards. The splitting is performed according to the predetermined number of the encrypted shards to be verified in support of steps 506, 508 of the process flow or method 500.

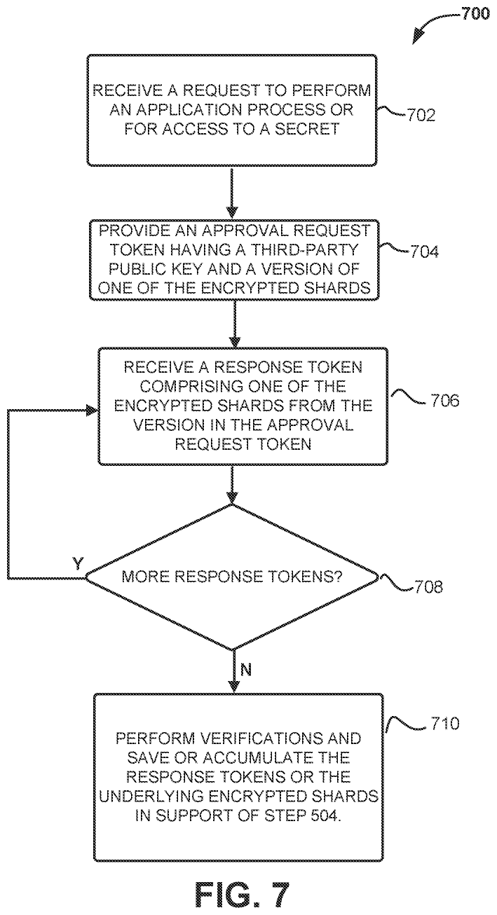

FIG. 7 illustrates a further process flow or method 700 for a system associated with protecting secrets with multi-party approval in a computer network, according to at least one embodiment. In at least one embodiment, the process flow or method 700 includes receiving (702) a request to perform an application process or for the access to the secret. The process flow or method 700 includes providing (704) an approval request token having a third-party public key and a version of the one of the encrypted shards. The version may include an approver key-encrypted shard that is to be decrypted by an approver private key and that is to be re-encrypted using a third-party public key to provide one of the encrypted shards to be used with the multi-party approval herein. In at least one embodiment, process flow or method 700 includes receiving (706), from the host machine, a response token having the one of the encrypted shards. A verifying (708) step may be formed to determine if more response tokens are required. The process flow or method 700 includes performing (710) verifications and then saving or accumulating the response tokens or the underlying encrypted shards in support of step 504 of the process flow or method 500. In at least one embodiment, the performing (710) of verifications can occur upon receipt (706) of every response token and prior to the next response token being received.

In at least one embodiment, the methods 500-700 may be used in an approach where the secret itself may be provided as the encrypted shards. For example, a server is provided (502) to accumulate (504) the encrypted shards that include parts of the secret as encrypted under a KeyA or a KeyL_Pub. For example, the splitting to provide the encrypted shards may be applied to an encrypted version of the secret (encrypted under KeyA or encrypted under KeyL_Pub). Then, each approval request token may be associated with a KeyL_Pub (such as by virtue of the secret being encrypted by KeyL_Pub and then split into KeyL_Pub-encrypted shards) and may be further encrypted by each approver's public key (Approver_Pub) when sent to each approver. Each signed approval response token may also be associated with a respective version of the KeyL_Pub-encrypted shard after decryption by each approver's private key (Approver_Pvt) and after signing that is associated with each approver's private key (Approver_Pvt).

In at least one embodiment, under such an approach, a further encrypted shard that may be a root or required encrypted shard (also encrypted under KeyL_Pub or KeyA) may be retained in server, such as the frontend server, and that may not be shared to an approver. In at least one embodiment, a communication (510) from a process to the trusted server may include all such KeyL_Pub (or KeyA)-encrypted shards and the IV, as accumulated (504) at different timepoints in the server and including the root or required encrypted shard (if one exists). The trusted server may return decrypted shards by decrypting the encrypted shards (encrypted under KeyL_Pub) using a KeyL_Pyt key. The process may perform decryption and combination (512) of all the shards to provide access to the secret, such as by revealing the secret, to the process, to a different process, referred to herein as an application process, or a backend server that requires access to the secret. For example, the process may combine all the split KeyL_Pub-encrypted shards to provide the KeyL_Pub-encrypted_secret. Then the process, together with the trusted server, may perform the decryption using the KeyL_Pvt key and any IVs to provide access to the secret.

In at least one embodiment, instead of KeyL_Pub and KeyL_Pvt keys in an asymmetric encryption of the secret, a symmetric KeyA from a trusted server may be used so that each approval request token may be associated with a KeyA (such as by virtue of the secret being encrypted by KeyA and then split into KeyA-encrypted shards). The remaining aspects, as described with the split KeyL_Pub-encrypted shards, may be applied here. In this embodiment, however, it is possible to change the KeyA without interacting with an Approver as the KeyA is a symmetry encryption of the secret. This allows KeyA to be cycled whereas the use of the asymmetric encryption of the secret, where the encrypted shards include the split KeyL_Pub-encrypted shards, may not allow cycling of the KeyL_Pub and KeyL_Pvt keys without interacting with an Approver.

In at least one embodiment, one or more of the methods herein may include a step or a sub-step where the decryption and the combination are to be performed on the encrypted shards by providing a key to be used to decrypt an encrypted version of the secret as part of the access to the secret. In at least one embodiment, one or more of the methods herein may include a step or a sub-step where the key is used with an initialization vector to decrypt the encrypted version of the secret. In at least one embodiment, one or more of the methods herein may include a step or a sub-step where individual ones of the version of the encrypted shards are encrypted using individual ones of public keys associated with individual ones of different approvers. In at least one embodiment, one or more of the methods herein may include a step or a sub-step where the individual ones of public keys are associated with respective ones of private keys that belong to respective ones of the different approvers.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for protecting secrets with multi-party approval in a computer network, comprising:
a server to accumulate a plurality of encrypted shards that are received in the server at different timepoints, the plurality of encrypted shards associated with a secret, the server further to enable a process that is remote from the server upon accumulating a predetermined number of the plurality of encrypted shards, the process to communicate with a trusted server and to cause decryption and combination to be performed on the plurality of encrypted shards to provide access to the secret.

2. The system of claim 1, wherein the decryption and the combination to be performed on the plurality of encrypted shards provide a key to be used to decrypt an encrypted version of the secret as part of the access to the secret.

3. The system of claim 2, wherein the key is used with an initialization vector to decrypt the encrypted version of the secret.

4. The system of claim 2, wherein the process is further to:
use one or more randomizers to provide the secret and the key;
encrypt the secret with at least the key to provide the encrypted version of the secret; and
enable splitting and encryption of the key to provide a version of the plurality of encrypted shards, wherein the splitting is performed according to the predetermined number of the plurality of encrypted shards.

5. The system of claim 4, wherein individual ones of the version of the plurality of encrypted shards are encrypted using individual ones of a plurality of public keys associated with individual ones of a plurality of different approvers.

6. The system of claim 5, wherein the individual ones of a plurality of public keys are associated with respective ones of a plurality of private keys that belong to respective ones of the different approvers.

7. The system of claim 1, wherein the server is further to:
receive a request to perform an application process or for the access to the secret;
provide an approval request token comprising a third-party public key and a version of the one of the plurality of encrypted shards, the version comprising an approver key-encrypted shard that is to be decrypted by an approver private key and that is to be re-encrypted using a third-party public key to provide the one of the plurality of encrypted shards; and
receive, from a host machine, a response token comprising the one of the plurality of encrypted shards.

8. The system of claim 1, wherein the process is a virtual instance to be destroyed upon providing at least the plurality of encrypted shards to the server.

9. The system of claim 1, wherein the process is further to:
use one or more randomizers to provide a new key to be used with the secret or to provide a new secret;
encrypt the secret or the new secret with at least the new key to provide a new encrypted version of the secret; and
perform a splitting and encryption on the new key or the new secret to provide a version of a plurality of new encrypted shards, wherein the splitting is performed to enable a new predetermined number of the plurality of encrypted shards.

10. The system of claim 1, wherein the plurality of encrypted shards comprise parts of the secret or comprise parts of a key to decrypt an encrypted version of the secret.

11. A method for protecting secrets with multi-party approval in a computer network, comprising:
providing a server to accumulate a plurality of encrypted shards that are associated with a secret and that are received in the server at different timepoints;
enabling a process that is remote from the server upon accumulating a predetermined number of the plurality of encrypted shards; and
communicating, between the process and a trusted server, to cause decryption and combination to be performed on the plurality of encrypted shards to provide access to the secret.

12. The method of claim 11, wherein the decryption and the combination to be performed on the plurality of encrypted shards provide a key to be used to decrypt an encrypted version of the secret as part of the access to the secret.

13. The method of claim 12, wherein the key is used with an initialization vector to decrypt the encrypted version of the secret.

14. The method of claim 12, further comprising:
using one or more randomizers to provide the secret and the key;
encrypting the secret with at least the key to provide the encrypted version of the secret; and
enabling splitting and encryption of the key to provide a version of the plurality of encrypted shards, wherein the splitting is performed according to the predetermined number of the plurality of encrypted shards.

15. The method of claim 14, wherein individual ones of the version of the plurality of encrypted shards are encrypted using individual ones of a plurality of public keys associated with individual ones of a plurality of different approvers.

16. The method of claim 15, wherein the individual ones of a plurality of public keys are associated with respective ones of a plurality of private keys that belong to respective ones of the different approvers.

17. The method of claim 11, further comprising:
receiving a request for an application process or for the access to the secret;
provide an approval request token comprising a third-party public key and a version of the one of the plurality of encrypted shards, the version comprising an approver key-encrypted shard that is to be decrypted by an approver private key and that is to be re-encrypted using a third-party public key to provide the one of the plurality of encrypted shards; and
receiving, from a host machine, a response token comprising the one of the plurality of encrypted shards.

18. A system for protecting secrets with multi-party approval in a computer network, comprising:
one or more processing units to enable accumulation of a plurality of encrypted shards that are received at different timepoints in a server and that are associated with a secret, to enable a process that is remote from the server, upon accumulating a predetermined number of the plurality of encrypted shards, the process to cause, in communication with a trusted server, decryption and combination to be performed on the plurality of encrypted shards to provide access to the secret.

19. The system of claim 18, the one or more processing units are further configured to:
use one or more randomizers to provide the secret and the key;
encrypt the secret with at least the key to provide the encrypted version of the secret; and
enable splitting and encryption of the key to provide a version of the plurality of encrypted shards, wherein the splitting is performed to provide the predetermined number of the plurality of encrypted shards.

20. The system of claim 18, the one or more processing units are further configured to:
receive a request for an application process or for the access to the secret;
provide an approval request token comprising a third-party public key and a version of the one of the plurality of encrypted shards, the version comprising an approver key-encrypted shard that is to be decrypted by an approver private key and that is to be re-encrypted using a third-party public key to provide the one of the plurality of encrypted shards; and
receive, from a host machine, a response token comprising the one of the plurality of encrypted shards.
